(19) United States
(12) Patent Application Publication
(10) Pub. No.: US 2008/0313667 A1
(43) Pub. Date: Dec. 18, 2008

(54) TELEVISION BROADCAST RECEIVING APPARATUS, TELEVISION BROADCAST REPRODUCING METHOD, AND TELEVISION BROADCAST REPRODUCING PROGRAM

(75) Inventor: Yousuke OHTSUKI, Hirakata (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi (JP)

(21) Appl. No.: 12/136,217

(22) Filed: Jun. 10, 2008

(30) Foreign Application Priority Data
Jun. 12, 2007 (JP) JP2007-154626

(51) Int. Cl. H04N 7/025; H04N 7/173

(52) U.S. Cl. 725/32; 725/131; 725/40; 348/569; 348/E05.105

(57) ABSTRACT

In order to effectively use a commercial message period in the television broadcast being reproduced, a television broadcast receiver includes a receiving and reproducing portion to receive television broadcast and to reproduce a video, a CM detecting portion to detect a commercial message included in the television broadcast, a main processing portion to execute a process of outputting a video, an operation accepting portion to accept an operation by a user, and a window control portion to display a notification window on a display device, in the case where the operation accepting portion accepts an operation directed to the main processing portion during a period from a start to an end of the commercial message detected by the CM detecting portion, to notify the user of the end of the commercial message when broadcast of the commercial message is finished.

This application is based on Japanese Patent Application No. 2007-154626 filed with Japan Patent Office on Jun. 12, 2007, the entire content of which is hereby incorporated by reference.

### BACKGROUND OF THE INVENTION

1. Field of the Invention

The present invention relates to a television broadcast receiving apparatus, a television broadcast reproducing method, and a television broadcast reproducing program. More particularly, the present invention relates to a television broadcast receiving apparatus which receives television broadcast including commercial messages, and a television broadcast reproducing method and a television broadcast reproducing program which are carried out by the television broadcast receiving apparatus.

2. Description of the Related Art

It is often the case that a television broadcast viewer would not like to view commercial messages (hereinafter, referred to as “CMs”) and wishes to avoid viewing them. The viewer may start zapping other channels when a program he/she is currently viewing switches from a main part to a CM.

Japanese Patent Application Laid-Open No. 05-316440, 10-051706, and 2003-219307 each disclose a technique wherein upon detecting switching of the main part of the program to a CM on the currently viewed channel, a video of another channel is displayed for a prescribed period of time or still images of other channels are displayed successively, and upon detecting switching of the main part of the program back from the CM on the original channel, the channel is switched automatically to the original one.

However, after the video of another channel is displayed, the viewer may wish to view the channel he/she is currently viewing, rather than going back to the original channel. In such a case, if the channel is automatically changed to the original channel, the viewer will need to change the channel again, possibly missing important scenes of the program.

Recently, a personal computer (PC) provided with a television broadcast receiving apparatus has come to the market, which allows the user to do other jobs such as browsing the homepages (Web pages) or transmitting/receiving e-mails when the television broadcast viewed on the PC is switched from the main part of the program to a CM. In this case as well, the above-described problems take place. More specifically, the PC user may have the following two needs while doing other jobs during the CM broadcast on the channel he/she is currently viewing:

(1) For the jobs such as creating email or documents where the user records the ideas come into mind, the user may wish to continue the job, without being interrupted, so as not to forget the ideas.

(2) In browsing the Web pages or the like, the user may become more interested in the content than the television broadcast program, in which case the user may wish to continue watching or viewing the content.

As such, the television broadcast viewer may wish to activate a program other than the program for viewing the television broadcast during a CM, to do a job by executing the other program. In this case, if the program for viewing the television broadcast is automatically activated, the viewer will need to reactivate the other program.

### SUMMARY OF THE INVENTION

The present invention has been accomplished in view of the foregoing problems, and an object of the present invention is to provide a television broadcast receiving apparatus which enables effective use of a commercial message period in the television broadcast being reproduced.

Another object of the present invention is to provide a television broadcast reproducing method and a television broadcast reproducing program which enable effective use of a commercial message period in the television broadcast being reproduced.

In order to achieve the above-described objects, according to an aspect of the present invention, a television broadcast receiving apparatus includes: a reproducing portion to receive television broadcast and to reproduce a video; a detecting portion to detect a commercial message included in the television broadcast; a process execution portion provided separately from the reproducing portion and to execute a process of outputting a video; an operation accepting portion to accept an operation by a user; and a notification portion to notify the user of the end of the commercial message when broadcast of the commercial message detected by the detecting portion is finished, in the case where an operation directed to the process execution portion is accepted by the operation accepting portion during a period from a start to an end of the commercial message detected by the detecting portion.

According to another aspect of the present invention, a television broadcast receiving apparatus includes: a reproducing portion to receive television broadcast and to reproduce a video; a detecting portion to detect a commercial message included in the television broadcast; a process execution portion provided separately from the reproducing portion and to execute a process of outputting a video; a video signal output portion to output a video signal for displaying a video; an operation accepting portion to accept an operation by a user; and a restoring portion to cause the video signal output portion to output a video signal in a same display state as the video signal that was output by the video signal output portion before a start of the commercial message detected by the detecting portion, in the case where the operation accepting portion accepts an operation directed to the process execution portion during a period from a start to the end of the commercial message detected by the detecting portion and, thereafter, broadcast of the commercial message detected by the detecting portion is finished with no operation directed to the process execution portion being accepted by the operation accepting portion for more than a predetermined period of time.

According to a further aspect of the present invention, a television broadcast reproducing method includes the steps of: receiving television broadcast and reproducing a video; detecting a commercial message included in the television broadcast; accepting an operation by a user; and in the case where an operation for causing execution of a process of outputting a video other than the video being reproduced is accepted during a period from a start to an end of the commercial message detected, notifying the user of the end of the commercial message when broadcast of the detected commercial message is finished.

According to a still further aspect of the present invention, a television broadcast reproducing method includes the steps of: receiving television broadcast and reproducing a video; detecting a commercial message included in the television broadcast; accepting an operation by a user; outputting a video signal for displaying a video; and in the case where an operation for causing execution of a process of outputting a video other than the video being reproduced is accepted during a period from a start to an end of the detected commercial message and, thereafter, broadcast of the detected commercial message is finished with no operation for execution of the process of outputting the other video being accepted for more than a predetermined period of time, outputting a video signal in a same display state as the video signal that was being output in the step of outputting a video signal at the time when the broadcast of the detected commercial message was started.

According to yet another aspect of the present invention, a television broadcast reproducing program product causes a computer to execute the steps of: receiving television broadcast and reproducing a video; detecting a commercial message included in the television broadcast; accepting an operation by a user; and in the case where an operation for causing execution of a process of outputting a video other than the video being reproduced is accepted during a period from a start to an end of the detected commercial message, notifying the user of the end of the commercial message when broadcast of the detected commercial message is finished.

According to yet another aspect of the present invention, a television broadcast reproducing program product causes a computer to execute the steps of receiving television broadcast and reproducing a video; detecting a commercial message included in the television broadcast; accepting an operation by a user; outputting a video signal for displaying a video; and in the case where an operation for causing execution of a process of outputting a video other than the video being reproduced is accepted during a period from a start to an end of the detected commercial message and, thereafter, broadcast of the detected commercial message is finished with no operation for execution of the process of outputting the other video being accepted for more than a predetermined period of time, outputting a video signal in a same display state as the video signal that was being output in the step of outputting a video signal at the time when the broadcast of the detected commercial message was started.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram schematically showing the functions of a television broadcast receiver according to a first embodiment of the present invention.

FIG. 2 is a first flowchart illustrating an example of the flow of television broadcast reproducing processing.

FIG. 3 is a first diagram showing an example of a time chart for switching windows.

FIGS. 4A to 4E show examples of a display screen.

FIGS. 5A and 5B show other examples of the display screen when the television window is inactive.

FIG. 6 is a second flowchart illustrating an example of the flow of the television broadcast reproducing processing.

FIG. 7 is a second diagram showing an example of the time chart for switching windows.

FIG. 8 is a functional block diagram schematically showing the functions of the television broadcast receiver according to a second embodiment of the present invention.

FIG. 9 is a third flowchart illustrating an example of the flow of the television broadcast reproducing processing.

FIG. 10 is a third diagram showing an example of the time chart for switching windows.

FIG. 11 is a fourth flowchart illustrating an example of the flow of the television broadcast reproducing processing.

FIG. 12 is a fifth flowchart illustrating an example of the flow of the television broadcast reproducing processing.

FIG. 13 is a fourth diagram showing an example of the time chart for switching windows.

FIG. 14 is a sixth flowchart illustrating an example of the flow of the television broadcast reproducing processing.

FIG. 15 is a fifth diagram showing an example of the time chart for switching windows.

FIG. 16 is a functional block diagram schematically showing the functions of the television broadcast receiver according to a third embodiment of the present invention.

FIG. 17 is a functional block diagram schematically showing the functions of the television broadcast receiver according to a fourth embodiment of the present invention.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated.

### First Embodiment

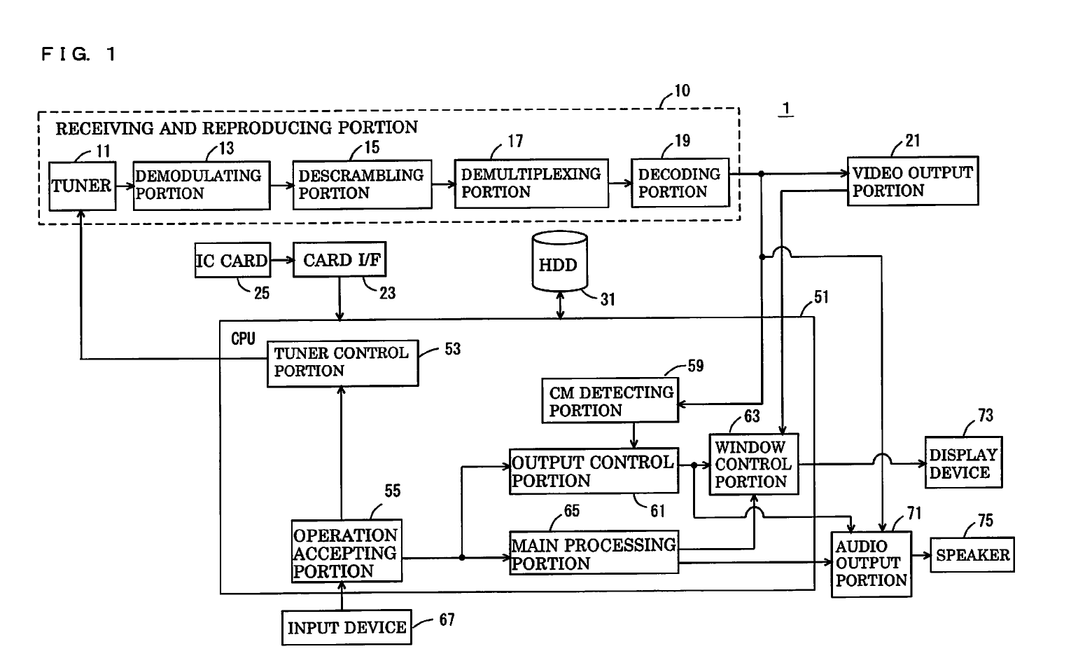

FIG. 1 is a functional block diagram schematically showing the functions of a television broadcast receiver according to a first embodiment of the present invention. Referring to FIG. 1, a television broadcast receiver 1 includes: a central processing unit (CPU) 51 which is responsible for overall control of television broadcast receiver 1; a receiving and reproducing portion 10 which receives and reproduces television broadcast; a video output portion 21; a display device 73; an audio output portion 71; a speaker 75 connected to audio output portion 71; a card I/F 23; a hard disk drive (HDD) 31 as a mass storage; and an input device 67.

Receiving and reproducing portion 10 includes a tuner 11, a demodulating portion 13, a descrambling portion 15, a demultiplexing portion 17, and a decoding portion 19. Tuner 11 is controlled by CPU 51 to receive the television broadcast waves and output the broadcast signals to demodulating portion 13. Tuner 11 receives the television broadcast waves of the frequency (channel) designated by CPU 51. Demodulating portion 13 demodulates the input broadcast signals to coded signals in MPEG 2-TS format or the like, and outputs the coded signals to descrambling portion 15.

Descrambling portion 15 is connected to demodulating portion 13, and receives the coded signals from demodulating portion 13. Since the coded signals are scrambled, descrambling portion 15 descrambles the coded signals input from demodulating portion 13 in accordance with a prescribed rule. It then outputs the descrambled coded signals to demultiplexing portion 17.

Demultiplexing portion 17 receives the coded signals from descrambling portion 15. The coded signals correspond to packetized data of video and audio data, which is time-division multiplexed. Demultiplexing portion 17 sequentially processes the input packets to generate digital video and audio data, and outputs them to decoding portion 19.

Decoding portion 19 is connected to demultiplexing portion 17, and receives the digital video and audio data from demultiplexing portion 17. Decoding portion 19 decodes the digital video and audio data, and outputs the decoded video data to video output portion 21 and CPU 51, and outputs the decoded audio data to audio output portion 71 and CPU 51.

Video output portion 21 converts the digital video data to analog video signals, and outputs them to CPU 51.

CPU 51 includes: a tuner control portion 53 which controls tuner 11; an operation accepting portion 55 which accepts an operation input by the user; a CM detecting portion 59 which detects a CM from video or audio signals; an output control portion 61 which controls video and audio outputs; a window control portion 63 which controls display of at least one window displayed on display device 73; and a main processing portion 65 which executes an application program for execution of a process.

CPU 51 is connected with a card I/F 23, to which an IC card 25 can be mounted. IC card 25 is provided with a semiconductor memory such as a flash ROM (Read Only Memory). CPU 51 reads and executes a television broadcast reproducing program stored in IC card 25. The recording medium for recording the television broadcast reproducing program executed by CPU 51 is not restricted to IC card 25. It may be a flexible disk, a cassette tape, an optical disk (CD-ROM (Compact Disc-ROM), MO (Magnetic Optical Disc), MD (Mini Disc), DVD (Digital Versatile Disc)), an optical card, or a semiconductor memory such as a masked ROM, an EPROM (Erasable Programmable ROM), an EEPROM (Electronically EPROM), or the like. As used herein, the “program” includes, not only the program directly executable by CPU 51, but also a program in the form of a source program, a compressed program, an encrypted program, and others.

Operation accepting portion 55 is connected with input device 67 in a wired or wireless manner, and accepts a user's operation input to input device 67. Input device 67 is a keyboard for inputting characters and symbols, or a pointing device such as a mouse. Input device 67 may be a remote controller. Operation accepting portion 55 outputs the accepted operation to tuner control portion 53, output control portion 61, and main processing portion 65.

In receipt of a channel selecting operation from operation accepting portion 55, tuner control portion 53 outputs to tuner 11 the channel (frequency) of the television broadcast to be received by tuner 11. This causes tuner 11 to receive the television broadcast waves of the frequency of the channel designated by the user.

Main processing portion 65 loads an application program stored in HDD 31 to a RAM (Random Access Memory) for execution of the application program. The application program may be, e.g., an email program for editing, transmitting, receiving, and displaying email, a browsing program for browsing Web pages on the Internet, a word processing program for composition of documents, a spreadsheet program, a graphics program for drawing graphics or figures, and the like, although not limited thereto. Further, the application program executed by main processing portion 65 is not restricted to the application program stored in HDD 31; it may be the one stored in IC card 25. In this case, main processing portion 65 reads the application program stored in IC card 25 via card I/F 23.

Here, description will be made about the case where main processing portion 65 executes the email program as the application program. In receipt of an instruction to activate the email program from operation accepting portion 55, main processing portion 65 executes the email program, thereby outputting application screens, such as an email editing screen for editing email, an email display screen for displaying received email and the like, to window control portion 63. The application screen comprises a video which includes moving and still images. Thus, main processing portion 65 carries out a process of outputting the video. Further, main processing portion 65 outputs sound which is output through execution of the email program, to audio output portion 71.

Window control portion 63 receives analog video signals from video output portion 21, and receives application screens from main processing portion 65. Window control portion 63 generates a display screen for displaying a window (hereinafter, referred to as a “television window”) for displaying the video signals input from video output portion 21, and a window (hereinafter, referred to as an “application window”) for displaying the application screens, and outputs the generated display screen to display device 73. This causes the display screen to be displayed on display device 73. The display screen comprises video signals for displaying the video on display device 73. Display device 73 may be a liquid crystal display (LCD), an organic EL (Electro Luminescence) display, a plasma display panel, or the like.

Window control portion 63 activates one of a plurality of windows and deactivates the other windows, in accordance with an instruction input from output control portion 61. The active window is displayed in preference to the inactive window. For example in the case where two windows overlap each other, the active window is displayed in front of the inactive window. In the case where the inactive window is minimized in size, when it is activated, it is displayed in the size the same as when it was active before being minimized.

In the active window, a user interface is rendered effective to the program for generating information to be displayed in the window. Thus, operation accepting portion 55 outputs the operation that is input from input device 67 when the application window is active, to main processing portion 65, and outputs the operation that is input from input device 67 when the television window is active, to output control portion 61 or tuner control portion 53.

For example, in the case where the television window is active, it is possible to input an instruction to switch channels or increase/decrease the volume, and the sound of the broadcast signals is output from speaker 75. In the case where the application window is active, it is possible to input characters for creating email, and the sound generated by the email program is output from speaker 75.

Audio output portion 71 receives digital audio data from decoding portion 19 and main processing portion 65. Audio output portion 71 converts the digital audio signals to analog audio signals, and outputs them to speaker 75. Audio output portion 71 outputs either the television audio signals obtained by converting the audio data input from decoding portion 19 or the application audio signals obtained by converting the audio data input from main processing portion 65, or the audio signals obtained by mixing the both, to speaker 75, according to an instruction input from output control portion 61. This causes the sound of the television broadcast and/or the sound output from the application program to be output from speaker 75.

CM detecting portion 59 receives video and audio signals from decoding portion 19, and detects a CM from the video signals or audio signals. Any well-known technique may be used for detecting the CM from the audio or video signals. Here, it is assumed that CM detecting portion 59 detects a CM from the audio or video signals in real time. CM detecting portion 59 detects a start time and an end time of a CM from the audio or video signals, and outputs a CM start signal indicating switching from the main part of the program to a CM and a CM end signal indicating switching from the CM to the main part of the program, to output control portion 61.

Output control portion 61 determines which window to activate from among a plurality of windows displayed by window control portion 63. Here, either the television window or the application window is selected and activated. Further, audio output portion 71 issues an instruction whether to output either the television audio signals or the application audio signals, or output the audio signals by mixing them.

Output control portion 61 receives a CM start signal and a CM end signal from CM detecting portion 59, and receives a user's operation from operation accepting portion 55. In the case where the CM start signal is input when the television broadcast is being reproduced, particularly when the television window is rendered active by window control portion 63, output control portion 61 determines whether an operation directed to main processing portion 65 has been input from operation accepting portion 55 subsequently. The operation directed to main processing portion 65 may be an operation of instructing execution of the application program, or an operation of activating a window for displaying an application screen when main processing portion 65 is executing the application program. When an operation of deactivating the active television window by minimizing it or the like is made, the inactive window is activated instead, which means that the operation of deactivating the television window is also regarded as one of the operations directed to main processing portion 65.

In the case where the operation directed to main processing portion 65 is input from operation accepting portion 55 following the input of the CM start signal, at the time when the CM end signal is input subsequently, output control portion 61 displays a window (hereinafter, referred to as a “notification window”) for notifying window control portion 63 of the end of the CM. This allows the user to know that the CM is finished while the user is editing, transmitting, receiving, or reading email with the application program executed. At this time, if the user wishes to continue the email processing, the user can continue the job. If the user wishes to view the television broadcast program with the email processing interrupted, the user may input an operation of activating the television window to input device 67.

The notification window for notification of the end of the CM is preferably a popup window or the like, which is displayed in the place different from that of the application window. This prevents the application window from being partly hidden by the notification window, and ensures good visibility of the application window.

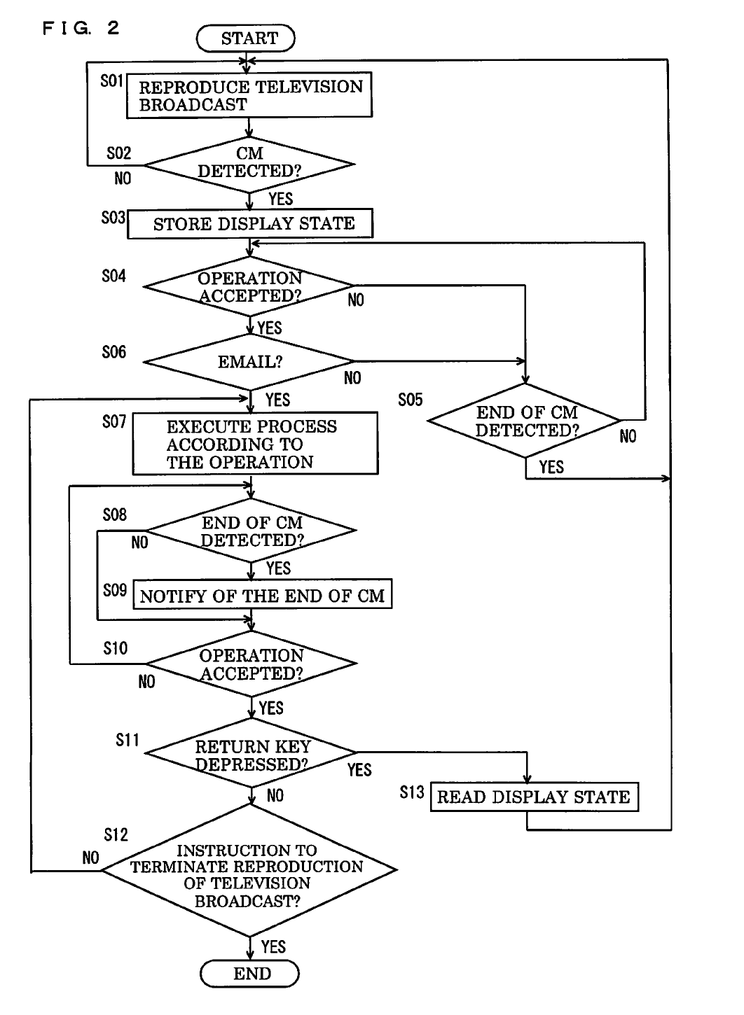

FIG. 2 is a first flowchart illustrating an example of the flow of television broadcast reproducing processing. The television broadcast reproducing processing is carried out by CPU 51 as it executes a television broadcast reproducing program. When the user inputs an operation of instructing reproduction of the television broadcast to input device 67, the television broadcast reproducing processing is carried out. Referring to FIG. 2, CPU 51 reproduces the television broadcast (step S01). At this time point, the television window is displayed on display device 73 and rendered active. It is then determined whether a CM has been detected (step S02). If the CM is detected, the process proceeds to step S03; otherwise, the process returns to step S01.

In step S03, a display state at the time of detection of the CM is stored. The display state at the time of detection of the CM refers to the state where the window for displaying the video signals of the television broadcast is active. The display state may also include the size and position of the window for displaying the video signals of the television broadcast.

In step S04, it is determined whether an operation has been accepted. If so, the process proceeds to step S06; otherwise, the process proceeds to step S05. In step S05, it is determined whether the end of the CM has been detected. If so, the process returns to step S01; otherwise, the process returns to step S04. That is, the process returns to step S01 in the case where the CM is finished with no operation accepted after detection of the CM. The process proceeds to step S06 in the case where at least one operation is accepted after detection of the CM.

In step S06, it is determined whether the accepted operation corresponds to an operation related to email. If the operation related to email is accepted, the process proceeds to step S07; otherwise, the process proceeds to step S05. The operation related to email corresponds to an operation of activating the application window. The operation of activating the application window includes an operation of minimizing the television window which is active at the time, because minimizing the television window leads to activation of the application window. Further, the operation of activating the application window includes an operation of activating an email program, and when the email program is being executed, it includes an operation of activating the application window for displaying an email editing screen for editing email, an email display screen for displaying received email and the like, or an operation directed to the application window. The operation directed to the application window includes an operation of editing the email.

If the accepted operation is not the operation related to email, the operation may be an operation of increasing/decreasing the volume, because the television window is active. In such a case, the process proceeds to step S05, and it returns to step S01 as in the case where the CM is finished with no operation being accepted after detection of the CM.

In step S07, a process in accordance with the accepted operation is carried out. This renders the application window active. Here, the process of creating, transmitting, receiving, or reading email is carried out.

In the following step S08, it is determined whether the end of the CM has been detected. If so, the process proceeds to step S09; otherwise, the process proceeds to step S10, with step S09 skipped. In step S09, the end of the CM is notified to the user. Specifically, a window for notification of the end of the CM is displayed on display device 73. This allows the user to know that the CM is finished while the user is editing, transmitting, receiving, or reading email with the application program executed. At this time, the user can continue the email processing job if he/she wishes.

Next, it is determined whether an operation has been accepted. If the operation is accepted (YES in step S10), the process proceeds to step S11. If the operation is not accepted (NO in step S10), the process returns to step S08. In step S11, it is determined whether the accepted operation corresponds to depression of a return key. The return key is prepared in input device 67. If the return key is depressed, the process proceeds to step S13; otherwise, the process proceeds to step S12.

In step S13, the display state stored in step S03 is read, and the window is displayed on display device 73 in the display state thus read. This causes, e.g., the television window to be displayed in the position and size in which it was displayed immediately before the start of the CM. As such, when the user wishes to view the television broadcast program with the email editing, transmitting, receiving, or reading process interrupted, the user is able to activate the window for displaying the video signals of the television broadcast with the simple operation of depressing the return key.

In step S12, it is determined whether the accepted operation corresponds to an instruction to terminate reproduction of the television broadcast. The instruction to terminate the reproduction of the television broadcast is detected when a certain key prepared in input device 67 is depressed. If the accepted operation corresponds to the instruction to terminate the reproduction of the television broadcast, reproduction of the television broadcast is terminated, and the process is finished. If the accepted operation is not the instruction to terminate the reproduction of the television broadcast, the process returns to step S07. This allows the email creating, transmitting, receiving, or reading process to be carried out in accordance with the accepted operation. In this manner, the email creating, transmitting, receiving, or reading process is carried out until depression of the return key, and once the return key is depressed, the window for displaying the video signals of the television broadcast is activated and displayed in the size and position in which it was displayed immediately before the start of the CM.

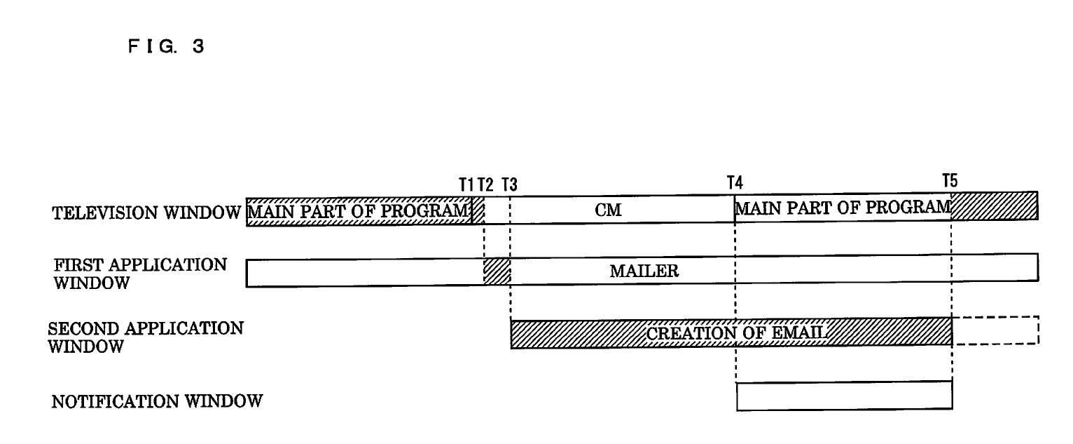

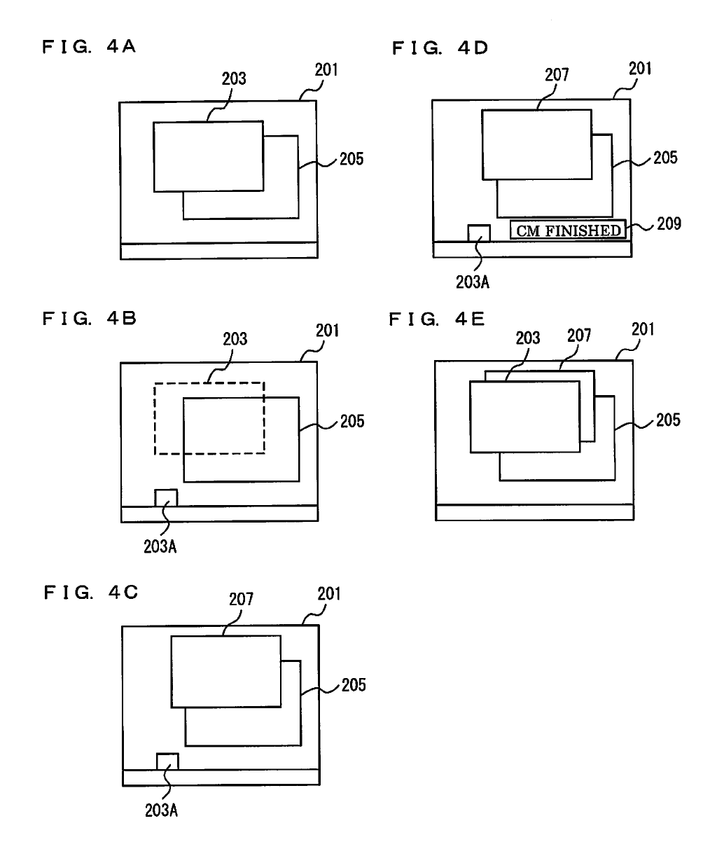

FIG. 3 is a first diagram showing an example of a time chart for switching windows. FIGS. 4A to 4E show examples of a display screen. In FIG. 3, a horizontal axis represents time, and the time zone in which the window is active is indicated by hatching for a television window, first and second application windows, and a notification window.

Referring to FIG. 3, with the television window firstly in an active state, a CM starts at time T1. FIG. 4A shows an example of the display screen at this time. A display screen 201 includes a television window 203 and a first application window 205. First application window 205 displays a main screen of the email program. While television window 203 and first application window 205 overlap each other, television window 203 which is active is displayed in front of first application window 205.

Following the time T1, when an operation of minimizing the television window is input at time T2, the television window is minimized and, at the same time, the first application window for displaying the main screen of the email program, which has been activated, becomes active. FIG. 4B shows the display screen at this time. When television window 203 indicated by broken lines in the figure is minimized, it is displayed as an icon 203A in the lower part of the display screen. It is noted that the broken lines in the figure indicate the area where television window 203 was displayed, which does not actually exist.

Subsequently, when an instruction to create new email is input at time T3, the second application window for displaying a screen for creating email is displayed and activated. FIG. 4C shows the display screen at this time. A second application window 207 is displayed in front of first application window 205.

Next, when the CM is finished at time T4, the notification window for notification of the end of the CM is displayed in a pop-up manner. FIG. 4D shows the display screen at this time. A notification window 209 having the characters “CM finished” displayed thereon is displayed in the lower right of display screen 201.

Following the time T4, when the user depresses a return key at time T5, the television window which had been minimized is activated and displayed in the size and position in which it was displayed before time T2. The notification window is closed, because it is unnecessary to display it now that the television window is active. FIG. 4E shows the display screen at this time. Television window 203 is displayed in the position and size in which it was displayed on display screen 201 in FIG. 4A. While television window 203, first application window 205, and second application window 207 overlap each other, television window 203 which is active is displayed in front of the other windows.

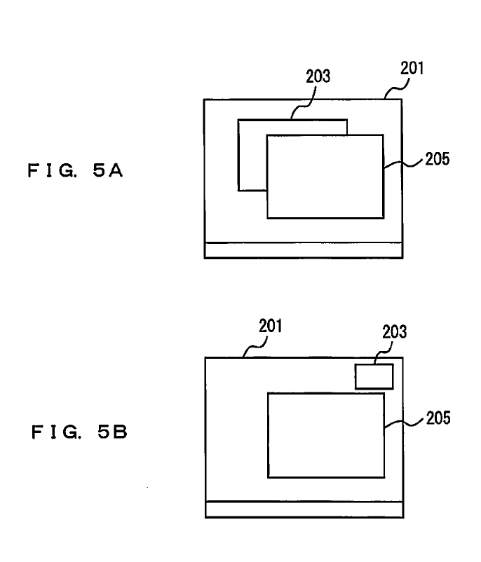

FIGS. 5A and 5B show other display examples when the television window is inactive. The television window is deactivated when an operation to do so is input. In this case, the other application window, first application window 205 in this case, is activated. Referring to FIG. 5A, display screen 201 displays television window 203 behind first application window 205. In FIG. 5B, television window 203 is reduced in size and displayed at the upper right corner of display screen 201 so as not to overlap first application window 205.

### <Modification>

In television broadcast receiver 1 according to the first embodiment described above, the television window is activated by an operation input by the user, which is specifically depression of the return key. In television broadcast receiver 1 according to a modification, the television window is automatically activated in the case where no operation directed to main processing portion 65, specifically no operation related to email, is performed over a predetermined period of time T after the start of the CM. If there is no operation over the predetermined period of time T, it is considered that the process executed by the email program, for example the email creating process, is finished or interrupted. In such a case, the television window is activated to prevent the viewer from missing the main part of the program.

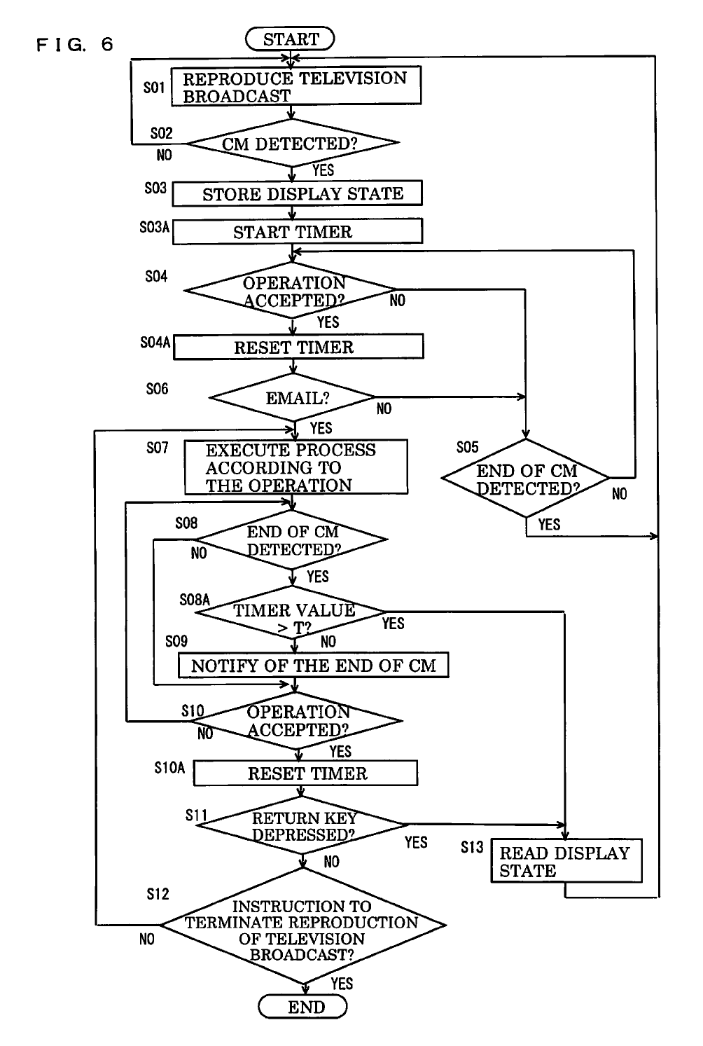

FIG. 6 is a second flowchart illustrating an example of the flow of the television broadcast reproducing processing, which is carried out by CPU 51 provided in television broadcast receiver 1 of the modification as it executes the television broadcast reproducing program. This television broadcast reproducing processing is carried out when the user inputs an operation of instructing reproduction of the television broadcast to input device 67. Referring to FIG. 6, the television broadcast reproducing processing shown in FIG. 6 differs from that in FIG. 2 in that steps S03A, S04A, S08A, and S10A are added. Otherwise, the processing is the same as that in FIG. 2, and thus, description will now be made mainly about the differences.

After the display state at the time of detection of the CM is stored in step S03, a timer is started in step S03A. The timer measure the time elapsed from the time when an operation is accepted to the time when a next operation is accepted. In the following step S04, it is determined whether an operation has been accepted. If so, the process proceeds to step S04A; otherwise, the process proceeds to step S05.

In step S04A, the timer is reset. With the timer reset to “0” upon acceptance of the operation, it is possible to measure the time from the time when the operation was accepted. In step S05, it is determined whether the end of the CM has been detected. If so, the process returns to step S01; otherwise, the process returns to step S04. That is, the process returns to step S01 in the case where the CM is finished with no operation accepted after the start of the CM. The process proceeds to step S06 when an operation is accepted after detection of the CM.

If the end of the CM is detected in step S08, the process proceeds to step S08A; otherwise, the process proceeds to step S10. If the operation is accepted in step S10, the timer is reset in step S10A. With the timer reset to “0” upon acceptance of the operation, the time from the acceptance of the operation can be measured again. If the accepted operation is not the depression of the return key (NO in step S11) or the instruction to terminate the reproduction of the television broadcast (NO in step S12), the process returns to step S07.

In step S08A, it is determined whether the timer value has exceeded a predetermined threshold value T. If the timer value has exceeded the threshold value T, i.e., when there is no operation input over the time T determined by the threshold value, the process proceeds to step S13. The timer value exceeds the threshold value T for example when the email editing, transmitting, receiving, or reading process is interrupted or finished. In such a case, the process proceeds to step S13, and the window for displaying the video signals of the television broadcast is activated and displayed in the position and size in which it was displayed immediately before the start of the CM. Activating the television window can prevent the user from missing the main part of the program following the end of the CM.

If the user inputs an operation during the email editing, transmitting, receiving, or reading process at an interval not exceeding the threshold value T, the process proceeds to step S09. In step S09, the end of the CM is notified to the user. Specifically, the notification window for notifying the end of the CM is displayed on display device 73. This allows the user to know that the CM is finished while the user is doing the email editing, transmitting, receiving, or reading process with the application program executed. At this time, the user may continue the email-related job if he/she wishes to do so.

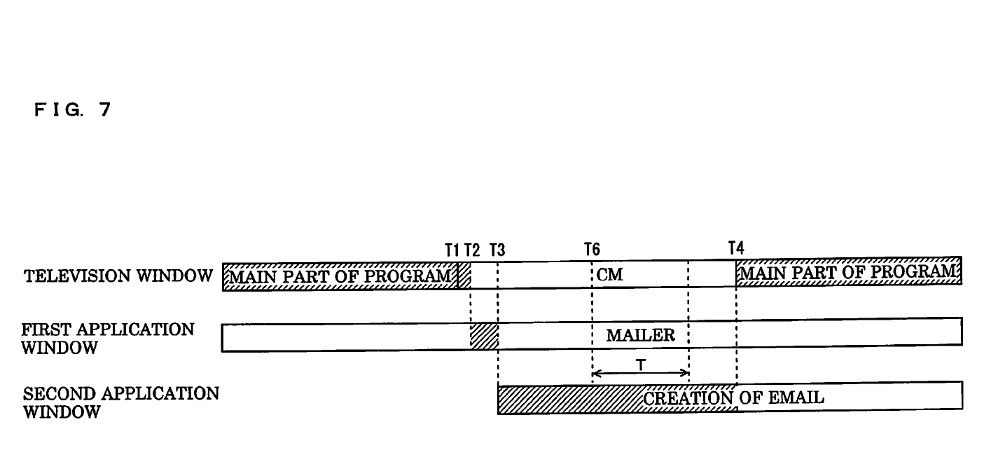

FIG. 7 is a second diagram showing an example of the time chart for switching windows. Referring to FIG. 7, with the horizontal axis representing time, the time zone in which the window is active is shown by hatching for the television window for displaying the video signals of the television broadcast, and the first and second application windows.

Firstly with the television window in the active state, a CM starts at time T1. Thereafter, when an operation of minimizing the television window is input at time T2, the television window is minimized and the first application window for displaying the main screen of the email program being activated at that time becomes active. Next, when an instruction to create new mail is input at time T3, the second application window for displaying the screen for creating email is displayed and activated. Thereafter, at time T6, the creation of the email is finished, and thereafter, there is no operation input. In this case, the timer measures the time that is elapsed from time T6 with no operation being input. At time T4 when the CM is finished, the timer value has exceeded the threshold value T. Thus, the television window which had been minimized is activated and displayed in the position and size in which it was displayed on the display screen at time T2.

This prevents the user from missing the main part of the program after the end of the CM. On the other hand, when the user is continuing the operation of creating the email during the email editing, transmitting, receiving, or reading process with the application program executed, the timer value would not exceed the threshold value T, in which case the user may continue the email-related process. The time chart in this case is identical to that shown in FIG. 3.

### Second Embodiment

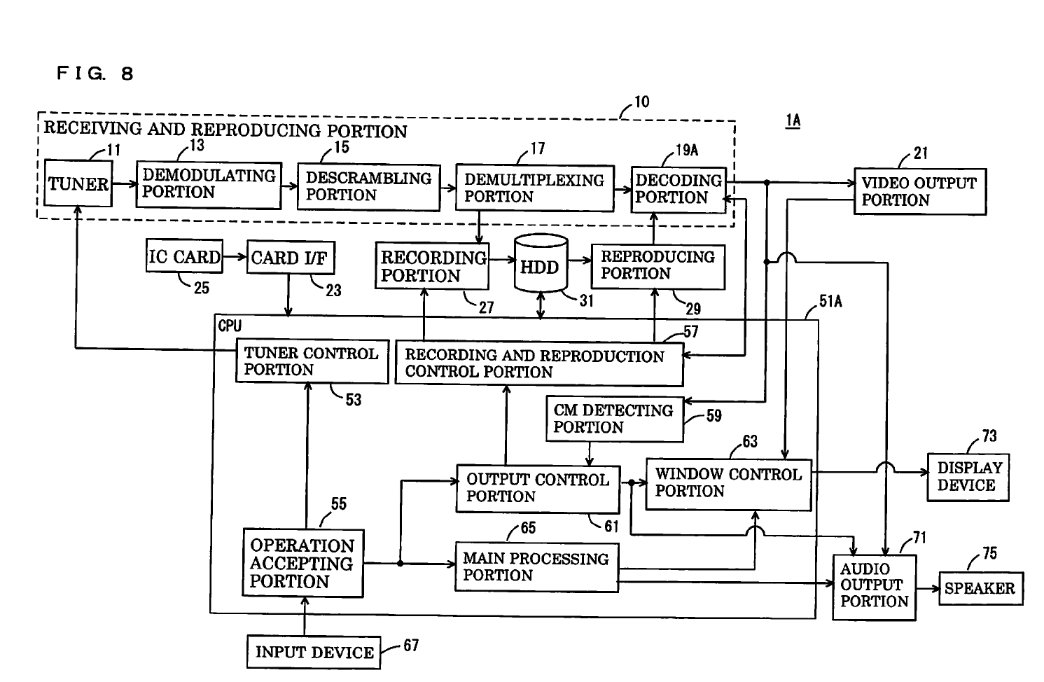

Hereinafter, a television broadcast receiver 1A according to a second embodiment of the present invention will be described. FIG. 8 is a functional block diagram schematically showing the functions of the television broadcast receiver of the second embodiment. Referring to FIG. 8, television broadcast receiver 1A of the second embodiment differs from television broadcast receiver 1 of the first embodiment shown in FIG. 1 in that a recording portion 27 and a reproducing portion 29 have been added, that a recording and reproduction control portion 57 has been added to CPU 51A, and that the decoding portion 19A has been modified.

Recording portion 27 is controlled by recording and reproduction control portion 57 in CPU 51A, and stores the digital video data and audio data input from demultiplexing portion 17 in HDD 31, in accordance with an instruction input from recording and reproduction control portion 57.

Reproducing portion 29 is controlled by recording and reproduction control portion 57, and reads the digital video data and audio data stored in HDD 31 for output to decoding portion 19A, in accordance with an instruction input from CPU 51A.

This enables the video data and audio data included in the television broadcast to be stored in HDD 31 in recording portion 27, while the video data and audio data stored in HDD 31 by recording portion 27 to be read in reproducing portion 29. It is noted however that the time when reproducing portion 29 reads data is behind the time when recording portion 27 stores the data, because reproducing portion 29 reads the video and audio data stored by recording portion 27, i.e., reproducing portion 29 reads the video and audio data after recording portion 27 stores them in HDD 31.

Decoding portion 19A receives the video and audio data from both of demultiplexing portion 17 and reproducing portion 29. Decoding portion 19A is controlled by recording and reproduction control portion 57 to decode the video and audio data input from either demultiplexing portion 17 or reproducing portion 29. In decoding the video and audio data input from reproducing portion 29, decoding portion 19A outputs the decoded video signals at a reproduction speed faster than a normal reproduction speed. For example, it outputs the video signals by thinning out the frames therefrom. While decoding portion 19A is configured to output the decoded video signals at the reproduction speed faster than the normal reproduction speed in this example, it may also be configured to output the decoded video signals at the normal reproduction speed.

Recording and reproduction control portion 57 controls recording portion 27, reproducing portion 29, and decoding portion 19A. Recording and reproduction control portion 57 receives a CM start signal and a CM end signal from CM detecting portion 59, and receives an inactive signal indicating that the television window has become inactive and an active signal indicating that the television window has become active from output control portion 61. When recording and reproduction control portion 57 receives the CM start signal from CM detecting portion 59 following reception of the inactive signal from output control portion 61, it outputs an instruction to start recording to recording portion 27. When recording and reproduction control portion 57 receives the active signal from output control portion 61 following the output of the recording start instruction, it outputs an instruction to start reproduction to reproducing portion 29 and, at the same time, outputs to decoding portion 19A an instruction to decode the video and audio data output from reproducing portion 29.

Recording and reproduction control portion 57 controls decoding portion 19A to output the decoded video data at a reproduction speed faster than a normal reproduction speed. At the time when the video data output from decoding portion 19A coincides in timing with the video data input from demultiplexing portion 17, recording and reproduction control portion 57 outputs to decoding portion 19A an instruction to decode the video and audio data input from demultiplexing portion 17 and, at the same time, outputs a stop instruction to recording portion 27 and reproducing portion 29, because it is unnecessary to record the video and audio data output from demultiplexing portion 17 when decoding portion 19A decodes the video and audio data it receives from demultiplexing portion 17.

In this manner, the video data of the main part of the program after the end of the CM is recorded on HDD 31, and when the user depresses the return key, the video data recorded on HDD 31 is reproduced at a double speed from the position corresponding to the end of the CM. This prevents the user from missing the main part of the program after the end of the CM.

While the video data recorded on HDD 31 is reproduced at the double speed, once the reproduction catches up with the video data of the television broadcast output from demultiplexing portion 17, the video data is switched to the one output from demultiplexing portion 17. This enables reproduction of the video of the television broadcast without a time lag. When the reproduction by reproducing portion 29 catches up with the video data of the television broadcast, the operations of recording portion 27 and reproducing portion 29 can be stopped, which reduces the power consumption.

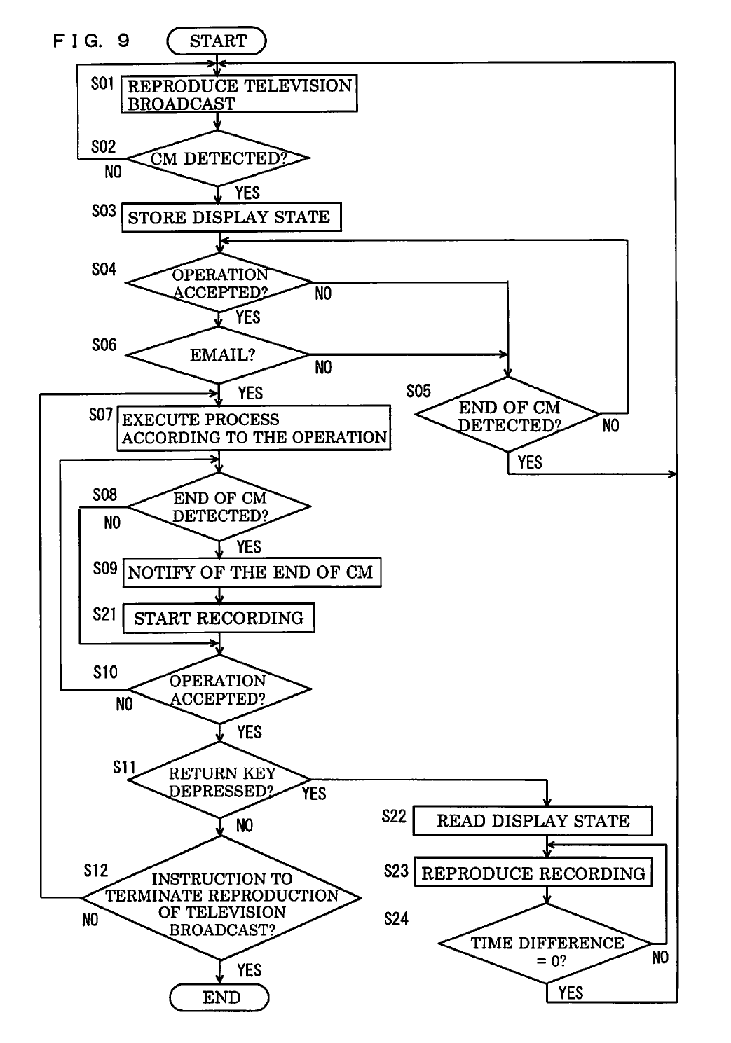

FIG. 9 is a third flowchart illustrating an example of the flow of the television broadcast reproducing processing. Referring to FIG. 9, the television broadcast reproducing processing in FIG. 9 differs from that in FIG. 2 in that step S21 has been added following step S09, and that step S13 has been replaced with steps S22 to S24. The processing shown in FIG. 9 will now be described mainly for the differences from the processing shown in FIG. 2.

When the end of the CM is detected in step S08, the end of the CM is notified to the user in step S09. Thereafter, recording is started (step S21), and the process proceeds to step S10. Specifically, an instruction to start recording is output to recording portion 27. This causes the video and audio data output by demultiplexing portion 17 to be recorded on HDD 31.

Then, if it is determined that an operation has been accepted after the end of the CM (YES in step S10) and if the operation accepted is the depression of the return key (YES in step S11), the process proceeds to step S22. In step S22, the display state stored in step S03 is read, and the window is displayed on display device 73 according to the read display state. This causes the television window to be displayed in the position and size in which it was displayed immediately before the start of the CM. When the user wishes to view the program of the television broadcast by interrupting the email editing, transmitting, receiving, or reading process, the user may perform the simple operation of depressing the return key to activate the television window.

In step S23, the video recorded on HDD 31 is reproduced. Specifically, a reproduction instruction is output to reproducing portion 29. This causes the video after the end of the CM to be displayed on the television window, thereby preventing the user from missing the video from the time when the CM is finished to the time when the user depresses the return key. The recorded video is reproduced at a double speed in this case, so that the difference in time between the video of the television broadcast and the recorded video being reproduced decreases gradually. In step S24, it is determined whether the time difference therebetween has become “0”. If so, the process returns to step S01; otherwise, the process returns to step S23.

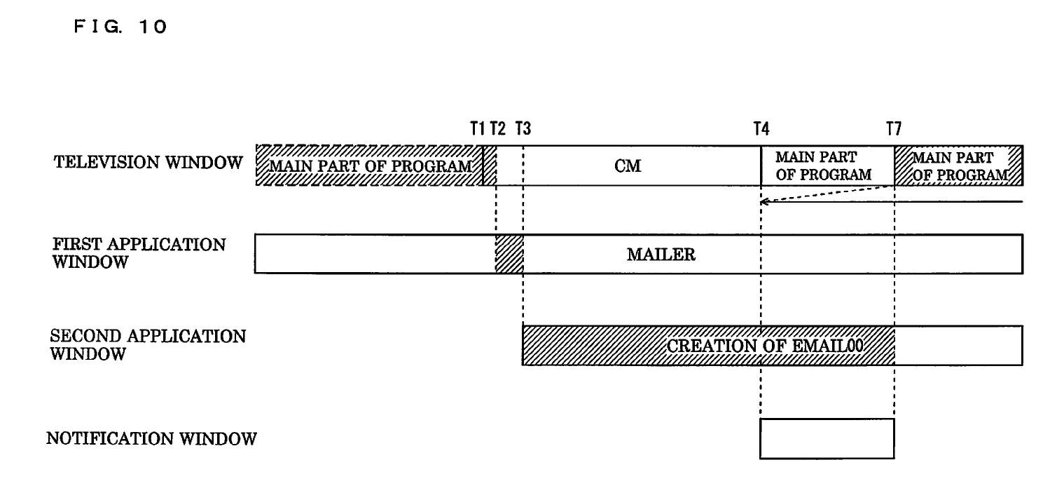

FIG. 10 is a third diagram showing an example of the time chart for switching windows. Referring to FIG. 10, with the horizontal axis representing time, the time zone in which the window is active is indicated by hatching for the television window for displaying the video signals of the television broadcast, the first and second application windows, and the notification window.

Firstly with the television window in the active state, a CM starts at time T1. Thereafter, when an operation to minimize the television window is input at time T2, the television window is minimized and, at the same time, the first application window for displaying the main screen of the email program being activated at that time becomes active. Next, when an instruction to create new mail is input at time T3, the second application window for displaying the screen for creating the email is displayed and rendered active. Thereafter, when the CM is finished at time T4, the notification window for notification of the end of the CM is displayed in a pop-up manner, and at the same time, recording of the video and audio data of the television broadcast is started. Thereafter, when the user depresses the return key at time T7, the television window which had been minimized is activated and displayed in the position and size in which it was displayed in the display screen at time T2. At this time, the recorded video data and audio data are reproduced, so that the video after the end of the CM is displayed on the television window. The notification window is closed at time T7, because it is unnecessary to display it now that the television window is active.

Depressing the return key causes the recorded video to be reproduced from the end of the CM, which prevents the user from missing the main part of the program from the time when the CM is finished to the time when the return key is depressed.

### <First Modification>

Television broadcast receiver 1A of the second embodiment may be modified such that the television window is automatically activated if the operation related to email is not made over a predetermined period of time T after the start of the CM, as in the modification of television broadcast receiver 1 of the first embodiment.

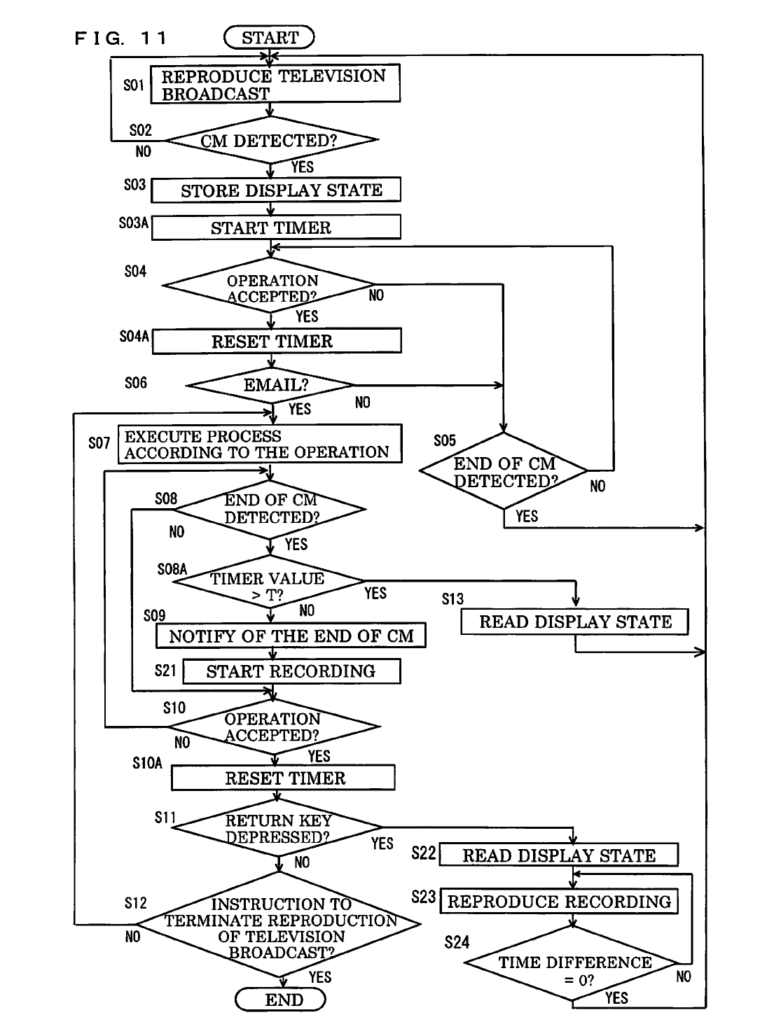

FIG. 11 is a fourth flowchart illustrating an example of the flow of the television broadcast reproducing processing. Referring to FIG. 11, the processing shown in FIG. 11 differs from the processing shown in FIG. 6 in that step S21 has been added following step S09, and that steps S22 to S24 have been added. Description will now be made mainly about the differences from the television broadcast reproducing processing shown in FIG. 2. The processing in steps S21 and S22 to S24 is as described above, and thus, description thereof will not be repeated here.

In the first modification of the second embodiment, if there is no operation input over the time T after an operation directed to the application program is input following the start of the CM, the television window for displaying the video of the television broadcast is automatically activated. The time chart in this case is identical to that shown in FIG. 7. When the operation directed to the application program is continued, the television window for displaying the video of the television broadcast is activated at the time when the return key is depressed. The time chart in this case is identical to that shown in FIG. 10. In either case, the video of the television broadcast is reproduced from the end of the CM, preventing the user from missing the main part of the program of the television broadcast. Further, the user is allowed to perform operations directed to the application program, i.e., create the email in this example, which enables effective use of the CM period.

### <Second Modification>

Upon detection of a CM, the CM start time or the CM end time may be detected after the CM is actually started or the CM is actually finished. For example, Japanese Patent Application No. 2006-077841 filed by the applicant discloses a technique of detecting a CM by detecting the silent period existent before and after the CM. In this case, the CM start time or end time is detected after the actual time of start or end of the CM. When the broadcast is recorded after detection of the end of the CM, the video of the main part of the program cannot be recorded from the time point corresponding to the end of the CM. To solve this problem, the recording may be started at the time when the start of the CM is detected. Although the CM is recorded as well, the video of the main part of the program following the CM can be recorded, enabling reproduction of the video of the main part of the program from the time point corresponding to the end of the CM.

In the second modification of the second embodiment, the CM start signal and the CM end signal output from CM detecting portion 59 include the CM start time and the CM end time, respectively.

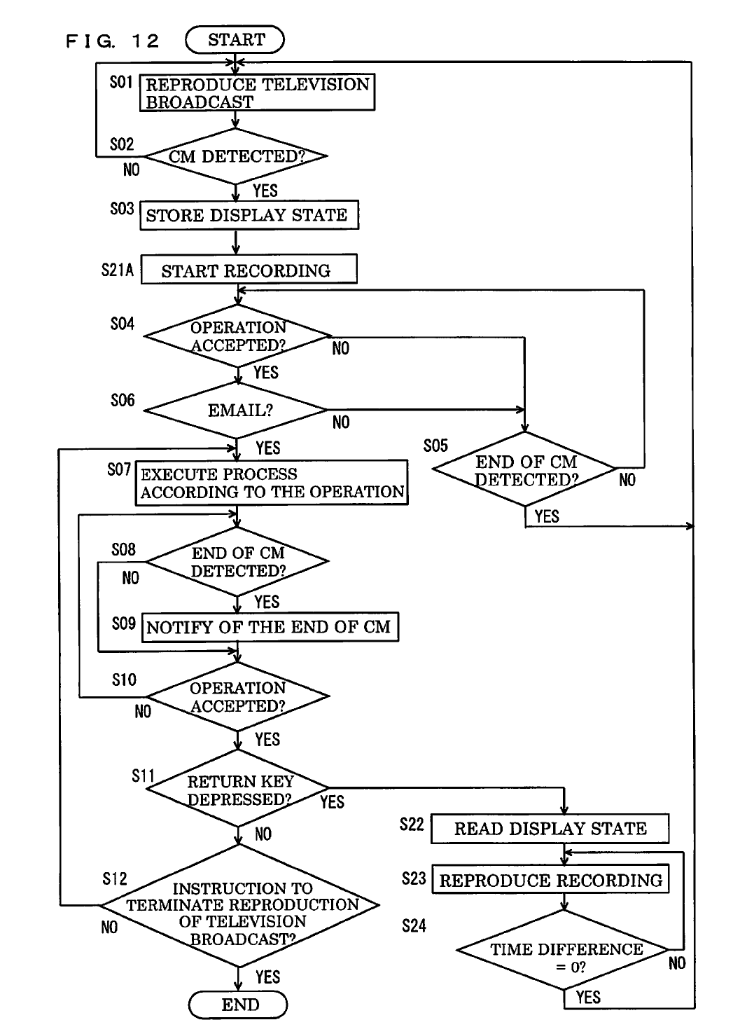

FIG. 12 is a fifth flowchart illustrating an example of the flow of the television broadcast reproducing processing. Referring to FIG. 12, the processing shown in FIG. 12 differs from the processing shown in FIG. 9 in that step S21 is replaced with step S21A which is added between steps S03 and S04.

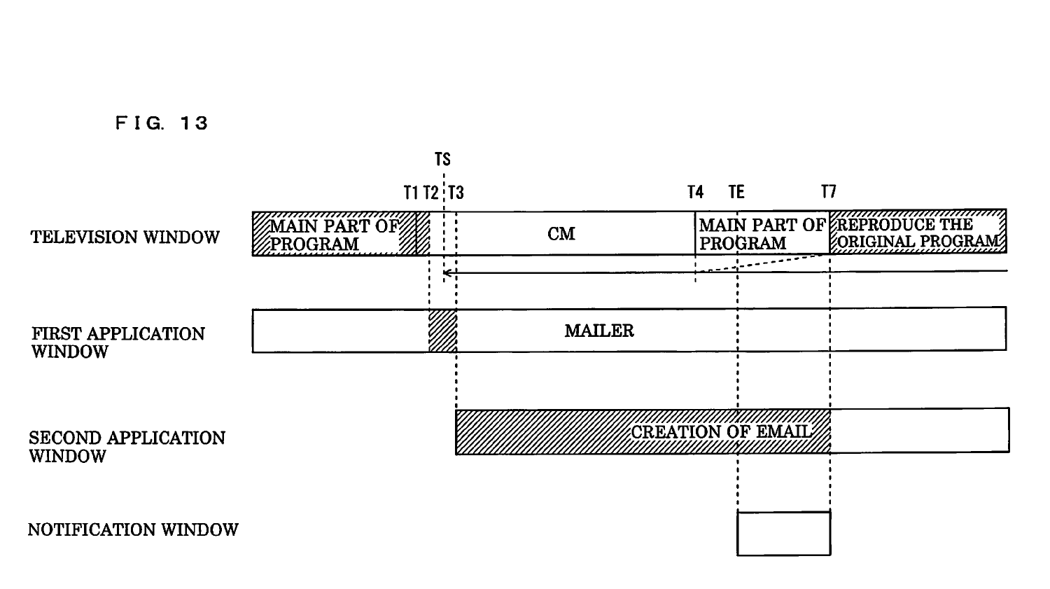

FIG. 13 is a fourth diagram showing an example of the time chart for switching windows. Referring to FIG. 13, with the horizontal axis representing the time, the time zone in which the window is active is indicated by hatching for the television window for displaying the video signals of the television broadcast, the first and second application windows, and the notification window.

Firstly with the television window in the active state, a CM starts at time T1. Thereafter, when an operation of minimizing the television window is input at time T2, the television window is minimized and, at the same time, the first application window for displaying the main screen of the email program being activated at that time is rendered active. At time TS when the start of the CM is detected, recording of the video and audio data of the television broadcast is started. The recording of the video and audio data of the television broadcast may be started at time T2 when the television window is minimized.

Next, when an instruction to create new mail is input at time T3, the second application window for displaying the screen for creating the email is displayed and rendered active. Thereafter, although the CM is finished at time T4, the end of the CM is detected at time TE. Thus, at time TE, the notification window for notification of the end of the CM is displayed in a pop-up manner. Thereafter, when the user depresses the return key at time T7, the television window which had been minimized is activated and displayed in the position and size in which it was displayed in the display screen at time T2. At this time, the recorded video and audio data are reproduced from the position recorded at time T4. This causes the video after the end of the CM to be displayed on the television window. The notification window is closed at time T7, because it is no longer necessary to display it as the television window is active.

Even if the end of the CM is detected after the CM is actually finished, once the return key is depressed, the recorded video is reproduced from the end of the CM, which prevents the user from missing the main part of the program from the end of the CM until the depression of the return key. This ensures effective use of the CM period.

### <Third Modification>

In television broadcast receiver 1A of the second modification of the second embodiment, the television window is activated by depression of the return key. In television broadcast receiver 1A of a third modification of the second embodiment, the television window is activated automatically if the email-related operation is not input over a predetermined period of time T after the start of the CM. When there is no operation over the predetermined period of time T, it is considered that the process executed by the email program, e.g. the process of creating email, has been finished or interrupted. In such a case, the television window is activated to prevent the user from missing the main part of the program.

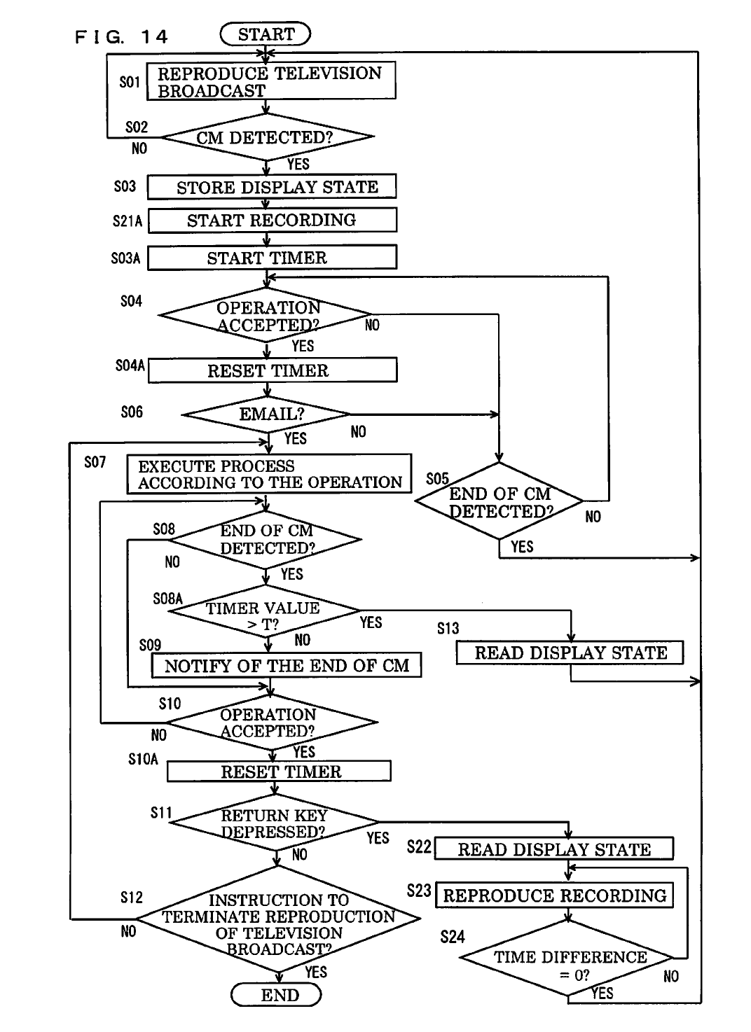

FIG. 14 is a sixth flowchart illustrating an example of the flow of the television broadcast reproducing processing. Referring to FIG. 14, the processing shown in FIG. 14 differs from that shown in FIG. 11 in that step S21 is replaced with step S21A which is added between step S03A and step S03A.

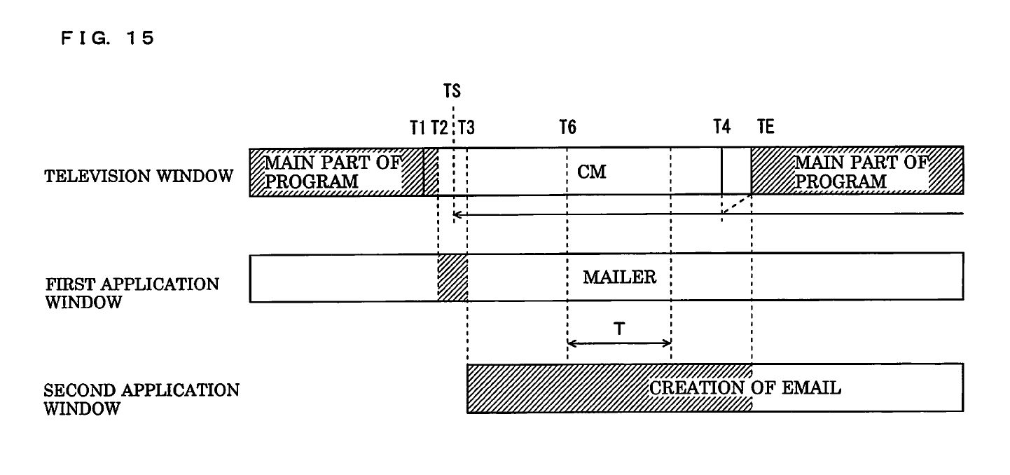

FIG. 15 is a fifth diagram showing an example of the time chart for switching windows. Referring to FIG. 15, with the horizontal axis representing time, the time zone in which the window is active is indicated by hatching for the television window for displaying the video signals of the television broadcast, and the first and second application windows.

Firstly with the television window in the active state, a CM starts at time T1. Thereafter, when an operation of minimizing the television window is input at time T2, the television window is minimized and, at the same time, the first application window for displaying the main screen of the email program being activated at that time is rendered active. At time TS when the start of the CM is detected, recording of the video and audio data of the television broadcast is started. The recording of the video and audio data of the television broadcast may be started at time T2 when the television window is minimized.

Next, when an instruction to create new mail is input at time T3, the second application window for displaying the screen for creating the email is displayed and activated. Thereafter, the creation of the email is finished at time T6, and there is no more operation input thereafter. In this case, the timer measures the time elapsed from time T6 with no operation being input. At time TE when the end of the CM is detected, the timer value has exceeded the threshold value T, and thus, the television window which had been minimized is activated and displayed in the position and size in which it was displayed in the display screen at time T2. The recorded video and audio data are reproduced from the position recorded at time T4 when the CM was finished. This causes the video after the end of the CM to be displayed on the television window.

According to television broadcast receiver 1A of the third modification of the second embodiment, the video is recorded from time TS when the start of the CM was detected (or from time T2 when the email-related operation was made), and at time TE when the end of the CM is detected with no operation being input over the predetermined period of time T, the recorded video is reproduced from the end of the CM. Accordingly, even if the time when CM detecting portion 59 detects the end of the CM is behind the time (CM end time) when the CM is actually finished, the user is prevented from missing the main part of the program from the time when the CM was actually finished until the time when CM detecting portion 59 detects the end of the CM. This ensures effective use of the CM period.

### Third Embodiment

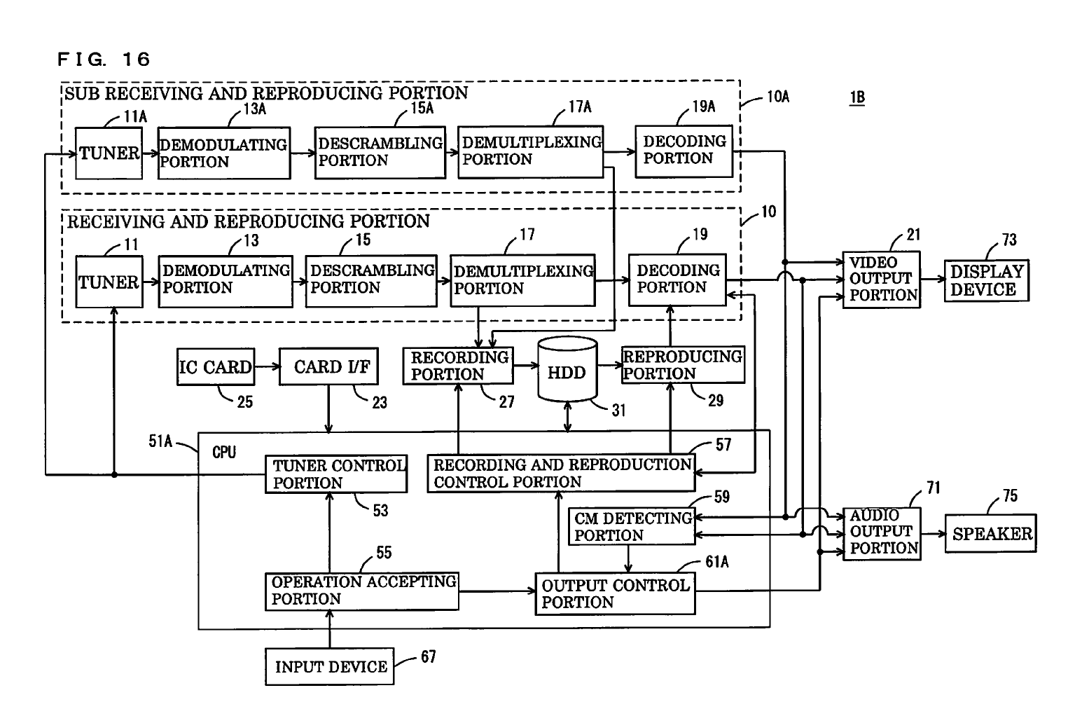

FIG. 16 is a functional block diagram schematically showing the functions of a television broadcast receiver 1B according to a third embodiment of the present invention. Referring to FIG. 16, television broadcast receiver 1B of the third embodiment differs from television broadcast receiver 1A of the second embodiment shown in FIG. 8 in that it has a sub receiving and reproducing portion 10A identical in configuration to receiving and reproducing portion 10, that main processing portion 65 and window control portion 63 have been deleted from CPU 51A, and that the output control portion 61A has been modified.

In television broadcast receivers 1 and 1A of the first and second embodiments, CPUs 51 and 51A each include main processing portion 65 and window control portion 63 and, with a plurality of windows displayed, the video output from receiving and reproducing portion 10 and the video output from main processing portion 65 are displayed on display device 73 at the same time. In contrast, in television broadcast receiver 1B of the third embodiment, either the video output from receiving and reproducing portion 10 or the video output from sub receiving and reproducing portion 10A is displayed on display device 73.

Output control portion 61A controls video output portion 21 to display either the video output from receiving and reproducing portion 10 or the video output from sub receiving and reproducing portion 10A on display device 73. Video output portion 21 outputs the video signals for displaying the video to display device 73. More specifically, output control portion 61A receives the CM start signal and the CM end signal from CM detecting portion 59, and a user's operation from operation accepting portion 55. In the case where the CM start signal is input during the time when output control portion 61A controls video output portion 21 to display the video of the television broadcast reproduced by receiving and reproducing portion 10 on display device 73, output control portion 61A determines whether an operation of switching the channel of the television broadcast has been input from operation accepting portion 55 thereafter. The operation of switching the channel is accepted at operation accepting portion 55 when the user depresses the channel button on input device 67, and is output to tuner control portion 53 and output control portion 61A.

Tuner control portion 53 controls sub receiving and reproducing portion 10A to receive the frequency of the channel accepted by operation accepting portion 55. Output control portion 61A instructs video output portion 21 to D/A convert the video and audio signals output from sub receiving and reproducing portion 10A, and output the resultant signals to display device 73. Thus, in the case where the channel is switched after the CM is started in the television broadcast of the channel being received by receiving and reproducing portion 10, the video of the program of the channel received by sub receiving and reproducing portion 10A is displayed on display device 73. In this case, receiving and reproducing portion 10 continuously receives the television broadcast of the channel it was receiving theretofore.

When the operation to switch the channel is input from operation accepting portion 55 following the input of the CM start signal, output control portion 61A displays a message notifying the end of the CM on display device 73 at the time when the CM end signal is input subsequently. For example, it displays the message on display device 73 as an OSD message. Thus, even when the user views another television broadcast program after the program the user was originally viewing has been switched to a CM, the user is able to know that the CM is finished in the television broadcast that the user was originally viewing. Further, if the user wishes to continuously view the television broadcast program on the other channel after switching, the user may do so. On the other hand, if the user wishes to view the television broadcast program that the user was originally watching before switching the channel, the user may input the operation of depressing the return key to input device 67.

Television broadcast receiver 1B according to the third embodiment carries out the television broadcast reproducing processing as shown in FIGS. 2, 6, 9, 11, 12, and 14. In this case, however, in step S06, it determines whether the channel has been switched, rather than determining whether the accepted operation corresponds to an operation related to email. Thereafter, the process may be moved to step S07 if the channel is switched; otherwise, the process may be moved to step S05.

In the third embodiment, when an operation of depressing the return key is input to input device 67 after the channel is switched during the CM, the channel returns to the one that was broadcasting the CM at the time of switching of the channel. Alternatively, the channel to be displayed after the input of the operation of depressing the return key to input device 67 may be any of the following channels. (1) In the case where a button (called a “bookmark button”) for designating a channel to return is prepared on a remote controller of input device 67, the channel displayed when the bookmark button was depressed. For example, the user may start viewing another channel after depressing the bookmark button while viewing the program the user wishes to return. Thereafter, when the operation of depressing the return key is input to input device 67, the channel that was being displayed when the user depressed the bookmark button is displayed. (2) The channel that the user viewed longer than any other channels after power on of the television set. (3) The channel that was displayed lastly among those that were displayed exceeding a certain period of time. The period is predetermined, which corresponds to the shortest time during which the viewer concentrates on viewing the program. (4) The channel that was firstly displayed among those that were broadcasting CMs at the time of switching of the channel. (5) The channel of the program that is set to be recorded.

### Fourth Embodiment

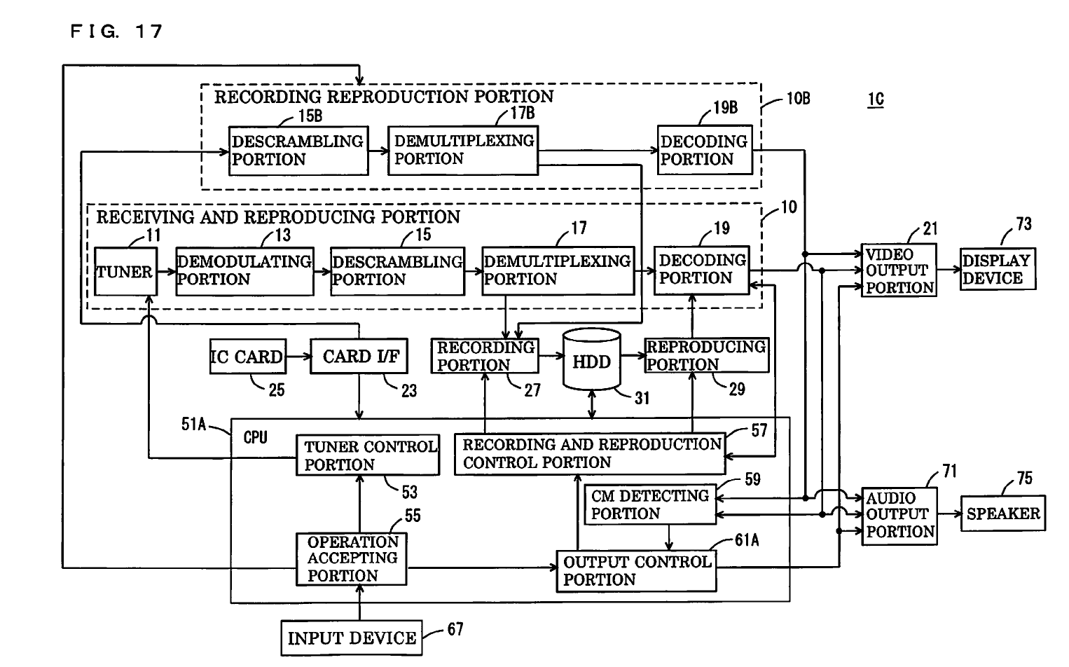

FIG. 17 is a functional block diagram schematically showing the functions of a television broadcast receiver 1C according to a fourth embodiment of the present invention. Referring to FIG. 17, television broadcast receiver 1C of the fourth embodiment differs from television broadcast receiver 1B of the third embodiment shown in FIG. 16 in that it has a recording reproduction portion 10B instead of sub receiving and reproducing portion 10A. In television broadcast receiver 1C of the fourth embodiment, either the video output from receiving and reproducing portion 10 or the video output from recording reproduction portion 10B is displayed on display device 73.

Recording reproduction portion 10B includes a descrambling portion 15B, a demultiplexing portion 17B, and a decoding portion 19B. Descrambling portion 15B is connected with card I/F 23, and when an instruction to reproduce a video content is input from operation accepting portion 55, it causes card I/F 23 to read a video content stored in IC card 25, and accepts the video content. The video content comprises coded signals, which are scrambled.

Descrambling portion 15B descrambles the video content input from card I/F 23 according to a prescribed rule. It then outputs the descrambled video content to demultiplexing portion 17B. Demultiplexing portion 17B and decoding portion 19B are identical to those described above, and thus, description thereof will not be repeated here. While it is assumed here that recording reproduction portion 10B reproduces a video content recorded on IC card 25, it may reproduce a video content recorded on an optical disc such as a DVD.

Output control portion 61A controls video output portion 21 to display either the video output from receiving and reproducing portion 10 or the video output from recording reproduction portion 10B on display device 73. Video output portion 21 outputs the video signals for displaying the video to display device 73. More specifically, output control portion 61A receives the CM start signal and the CM end signal from CM detecting portion 59, and a user's operation from operation accepting portion 55. In the case where output control portion 61A receives the CM start signal while it controls video output portion 21 to display the video of the television broadcast reproduced by receiving and reproducing portion 10 on display device 73, output control portion 61A determines whether an operation for reproducing the video content has been input from operation accepting portion 55 thereafter. The operation for reproducing the video content is accepted at operation accepting portion 55 when the user depresses a content reproduction button prepared in input device 67. When the operation for reproducing a video content is input to operation accepting portion 55, output control portion 61A instructs video output portion 21 to D/A convert the video signals output from recording reproduction portion 10B for output to display device 73. Thus, in the case where the content reproduction instruction is input after the CM is started in the television broadcast of the channel received by receiving and reproducing portion 10, the video obtained by analog converting the video signals output from recording reproduction portion 10B is displayed on display device 73. In this case, receiving and reproducing portion 10 continuously receives the television broadcast of the channel it was receiving theretofore.

When the operation of reproducing a content is input from operation accepting portion 55 following the input of the CM start signal, output control portion 61A displays a message for notification of the end of the CM at the time when the CM end signal is input subsequently. For example, it displays the message on display device 73 as an OSD message. Thus, even when the user views a video content stored in IC card 25 after the program the user was originally watching has been switched to a CM, the user is able to know that the CM is finished in the television broadcast that the user was originally watching. The user may continuously view the video content stored in IC card 25 if the user wishes to do so. If the user wishes to view the television broadcast program that the user was originally watching, the user may input the operation of depressing the return key to input device 67.

Television broadcast receiver 1C of the fourth embodiment is able to carry out the television broadcast reproducing processing as shown in FIGS. 2, 6, 9, 11, 12, and 14. In this case, however, in step S06, it determines whether a content reproduction instruction has been accepted, rather than determining whether the accepted operation corresponds to the operation related to email. Thereafter, the process may be moved to step S07 if the instruction to reproduce the video content stored in IC card 25 is input; otherwise, the process may be moved to step S05.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A television broadcast receiving apparatus, comprising:
a reproducing portion to receive television broadcast and to reproduce a video;
a detecting portion to detect a commercial message included in the television broadcast;
a process execution portion provided separately from said reproducing portion and to execute a process of outputting a video;
an operation accepting portion to accept an operation by a user; and
a notification portion to notify the user of the end of the commercial message when broadcast of the commercial message detected by said detecting portion is finished, in the case where an operation directed to said process execution portion is accepted by said operation accepting portion during a period from a start to an end of the commercial message detected by said detecting portion.

2. The television broadcast receiving apparatus according to claim 1, further comprising:
a video signal output portion to output a video signal for displaying a video; and
a restoring portion, when a prescribed operation is accepted by said operation accepting portion after the notification by said notification portion, to cause said video signal output portion to output a video signal in a same display state as the video signal that was output from said video signal output portion before the start of the commercial message detected by said detecting portion.

3. The television broadcast receiving apparatus according to claim 2, further comprising:
a recording portion to record the video reproduced by said reproducing portion; and
a recording reproduction portion to reproduce the video recorded by said recording portion; wherein
in the case where said restoring portion controls said video signal output portion to output a video signal in the same display state as the video signal output before the start of the commercial message, said recording reproduction portion reproduces the video recorded by said recording portion from the time point of the end of the commercial message detected by said detecting portion, and said video signal output portion outputs a video signal for displaying the video reproduced by said recording reproduction portion.

4. The television broadcast receiving apparatus according to claim 1, wherein said process execution portion executes an application program.

5. The television broadcast receiving apparatus according to claim 1, wherein said process execution portion includes a sub recording reproduction portion to read and reproduce a recorded video.

6. The television broadcast receiving apparatus according to claim 1, further comprising a video signal output portion to output a video signal for displaying said video, wherein
said process execution portion receives and reproduces television broadcast,
said detecting portion detects a commercial message included in the television broadcast reproduced by said reproducing portion,
in the case where an instruction to switch a channel is accepted by said operation accepting portion during a period when said video signal output portion is outputting a video signal for displaying the video of the television broadcast reproduced by said reproducing portion, said video signal output portion outputs a video signal for displaying a video of the television broadcast reproduced by said process execution portion, and
in the case where an instruction to switch a channel is accepted by said operation accepting portion during a period from a start to an end of the commercial message detected by said detecting portion, said notification portion notifies the user of the end of the commercial message when broadcast of the commercial message detected by said detecting portion is finished.

7. A television broadcast receiving apparatus, comprising:
a reproducing portion to receive television broadcast and to reproduce a video;
a detecting portion to detect a commercial message included in the television broadcast;
a process execution portion provided separately from said reproducing portion and to execute a process of outputting a video;
a video signal output portion to output a video signal for displaying a video;
an operation accepting portion to accept an operation by a user; and
a restoring portion to cause said video signal output portion to output a video signal in a same display state as the video signal that was output by said video signal output portion before a start of the commercial message detected by said detecting portion, in the case where said operation accepting portion accepts an operation directed to said process execution portion during a period from a start to the end of the commercial message detected by said detecting portion and, thereafter, broadcast of the commercial message detected by said detecting portion is finished with no operation directed to said process execution portion accepted by said operation accepting portion for more than a predetermined period of time.

8. The television broadcast receiving apparatus according to claim 7, wherein in the case where a prescribed operation is accepted by said operation accepting portion after the commercial message detected by said detecting portion is finished with the operation directed to said process execution portion continued, said restoring portion causes said video signal output portion to output a video signal in a same display state as the video signal that was output by said video signal output portion before the start of the commercial message detected by said detecting portion.

9. The television broadcast receiving apparatus according to claim 7, further comprising:
a recording portion to record the video reproduced by said reproducing portion; and
a recording reproduction portion to reproduce the video recorded by said recording portion; wherein
in the case where said restoring portion controls said video signal output portion to output a video signal in a same display state as the video signal output before the start of the commercial message, said recording reproduction portion reproduces the video recorded by said recording portion from the time point of the end of the commercial message detected by said detecting portion, and said video signal output portion outputs a video signal for displaying the video reproduced by said recording reproduction portion.

10. The television broadcast receiving apparatus according to claim 7, wherein said process execution portion includes a process execution portion to execute an application program.

11. The television broadcast receiving apparatus according to claim 7, wherein said process execution portion includes a sub recording reproduction portion to read and reproduce a recorded video.

12. The television broadcast receiving apparatus according to claim 7, wherein
said process execution portion receives and reproduces television broadcast,
said detecting portion detects a commercial message included in the television broadcast reproduced by said reproducing portion,
in the case where an instruction to switch a channel is accepted by said operation accepting portion during a period when said video signal output portion is outputting a video signal for displaying a video of the television broadcast reproduced by said reproducing portion, said video signal output portion outputs a video signal for displaying a video of the television broadcast reproduced by said process execution portion, and
in the case where an operation directed to said process execution portion is accepted by said operation accepting portion during a period from a start to an end of the commercial message detected by said detecting portion and, thereafter, broadcast of the commercial message detected by said detecting portion is finished with no operation directed to said process execution portion accepted by said operation accepting portion for more than a predetermined period of time, said restoring portion causes said video signal output portion to output a video signal for displaying the video of the television broadcast reproduced by said reproducing portion.

13. A television broadcast reproducing method, comprising the steps of:
receiving television broadcast and reproducing a video;
detecting a commercial message included in the television broadcast;
accepting an operation by a user; and
in the case where an operation for causing execution of a process of outputting a video other than said video being reproduced is accepted during a period from a start to an end of said detected commercial message, notifying the user of the end of the commercial message when broadcast of said detected commercial message is finished.

14. A television broadcast reproducing method, comprising the steps of:
receiving television broadcast and reproducing a video;
detecting a commercial message included in the television broadcast;
accepting an operation by a user;
outputting a video signal for displaying a video; and
in the case where an operation for causing execution of a process of outputting a video other than said video being reproduced is accepted during a period from a start to an end of said detected commercial message and, thereafter, broadcast of said detected commercial message is finished with no operation for execution of the process of outputting said other video accepted for more than a predetermined period of time, outputting a video signal in a same display state as the video signal that was output in said step of outputting a video signal at the time when the broadcast of said detected commercial message was started.

15. A television broadcast reproducing program product causing a computer to execute the steps of:
receiving television broadcast and reproducing a video;
detecting a commercial message included in the television broadcast;
accepting an operation by a user; and
in the case where an operation for causing execution of a process of outputting a video other than said video being reproduced is accepted during a period from a start to an end of said detected commercial message, notifying the user of the end of the commercial message when broadcast of said detected commercial message is finished.

16. A television broadcast reproducing program product causing a computer to execute the steps of:
receiving television broadcast and reproducing a video;
detecting a commercial message included in the television broadcast;
accepting an operation by a user;
outputting a video signal for displaying a video; and
in the case where an operation for causing execution of a process of outputting a video other than said video being reproduced is accepted during a period from a start to an end of said detected commercial message and, thereafter, broadcast of said detected commercial message is finished with no operation for execution of the process of outputting said other video accepted for more than a predetermined period of time, outputting a video signal in a same display state as the video signal that was output in said step of outputting a video signal at the time when the broadcast of said detected commercial message was started.
